(19) United States
(12) Patent Application Publication
(10) Pub. No.: US 2010/0275512 A1
(43) Pub. Date: Nov. 4, 2010

(54) PLANT CULTIVATION METHOD

(76) Inventor: TE-CHIH NIEN, Changhua City (TW)

Correspondence Address: LEONG C LEI, PMB # 1008, 1867 YGNACIO VALLEY ROAD, WALNUT CREEK, CA, 94598, US

(21) Appl. No.: 12/730,232

(22) Filed: Mar. 24, 2010

(30) Foreign Application Priority Data
Apr. 30, 2009 (TW) 098114481

(51) Int. Cl. A01G 9/02

(52) U.S. Cl. 47/66.7

(57) ABSTRACT

Disclosed is a novel plant cultivation method applicable to classification cultivation with simplified management, in which an enclosed box like container or greenhouse like space provides an enclosed cultivation space having a bottom forming a water reservoir for collecting condensed water so as to realize natural circulation of water evaporation and convection, by which cultivation control and management is realized in an almost watering free manner. Further, arranged outside the enclosed space is a carbon dioxide generation device in connection with an air compressor, which through proper treatment of drying and heating, supplies the interior cultivation space with pressurization and supplement of carbon dioxide and nutrients through piping arrangement, whereby the growth of plants can carry out completely free of pest damage or application of pesticides. Through the control of sunlight, the growth and cultivation of plants can be realized in a management simplified, secured, and stable manner.

### (a) TECHNICAL FIELD OF THE INVENTION

The present invention generally relates to a novel plant cultivation method, and more particularly to a novel plant cultivation method that provides an enclosed planting and cultivation space in which water, air, and nutrients, which construct an environment for plant growth, are contained and change with the temperature rise caused by sun shining for circulation and use so as to make a substantial reduction of costs for plant cultivation management and that provides a spatial arrangement and setup of box-like cultivation container or an enclosed space to facilitate classification cultivation of different species of plants, and particularly, to facilitate simplified cultivation management of various kinds of flowers, plants, or vegetables so that success rate of plant cultivation and adjustment and control of plant growth period can be ensured through proper control of cultivation space and growth conditions, making plant cultivation simplified and more economical and practical in view of scientific management.

### (b) DESCRIPTION OF THE PRIOR ART

The development of traditional plant cultivation modes, from the early day weather dependent plant growing to the modern cultivation of high economic crops, such as flowers or special seasonal fruits and vegetables clearly indicates that the technological development of modem cultivation of plant has already reached a considerable level. However, all of the known cultivation methods are mostly based on large-scale greenhouse facility, added with automatic watering arrangement and hydroponics like cultivation channels, in order to achieve automatically controlled cultivation management. In other words, the arrangement of the whole cultivation facility is simply employing mechanical devices to facilitate the management of plant cultivation. Consequently, the overall cost of production is extremely high, and the success rate of actual cultivation is hard to control. Particularly, in the design of large-scale greenhouses, in order to prevent external contamination and pests and diseases, it often requires installing multiple protection devices and the access control of personnel also requires management of hygiene. Apparently, the management operation is still the same as the traditional ways of management. In case that diversified plant cultivations are done in the same space, the difference of growth characteristics between different plants will result in trouble of management. It is thus desired to provide a simple way of plant cultivation that ensures the stability and improvement of cultivation quality while at the same time further enhance the technology and value of the agricultural cultivation, and further improvement is desired for the existing large-scale planting modes.

### SUMMARY OF THE INVENTION

In view of the drawbacks of the known plant cultivation mode that requires high costs and does not allow for effective economic management and increase of values, based on years' experience of plant growth and cultivation, the present inventor carried out a variety of researches and developed a novel plant cultivation method, which uses a cultivation space provided by a hermetically enclosed box like contain, added with a pressurization device and various gas generation device to set up an enclosed cultivation space in which air, water, and nutrients that are needed for the growth of plants are supplemented in a circulatory arrangement to realize a self-sustaining balance of these conditions so as to effectively overcome the troubles and drawbacks of the conventional plant cultivation that require repeated supplement and close observation and management and thus high costs.

The primary objective of the present invention is to set up a cultivation space with a simple and enclosed container so as to isolate the cultivated plants from the outside environment, to provide water and air that are necessary to the growth of plants by pouring a proper amount of water in a water reservoir and inducing convection through water evaporation and condensation, and to realize supplement of proper amount of carbon dioxide that is subjected to heating and pressurization and water that contains fertilizers and nutrients through pre-arranged piping, whereby safe and quick growth of plants can be achieved, completely free of damage caused by pests and concerns of contamination caused by pesticides, and cultivation techniques and management are simplified to effectively reduce the costs of cultivation and satisfy the need for management and use of diversified cultivation, so that the cultivation of flowers, large plants, vegetables, grapes, or fruits can be realized in a high economic value and safe management manner.

Another objective of the present invention is to make an arrangement of pre-manufactured diverse cultivation containers, which can individually carry plants or can alternatively be commonly set up in a large greenhouse like space for unified cultivation management, while allowing for the flexibility of diversified cultivation so that through computer based scientific control management, the plant cultivation techniques can better meet the economic and practical value of industrial development and use.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing the installation for a plant cultivation method according to the present invention.

FIG. 2 is a schematic view showing a large-scale cultivation container according to the present invention.

FIG. 3 is a schematic view showing a small-scale cultivation container according to the present invention.

FIG. 4 is a schematic view showing water spraying inside the cultivation container according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

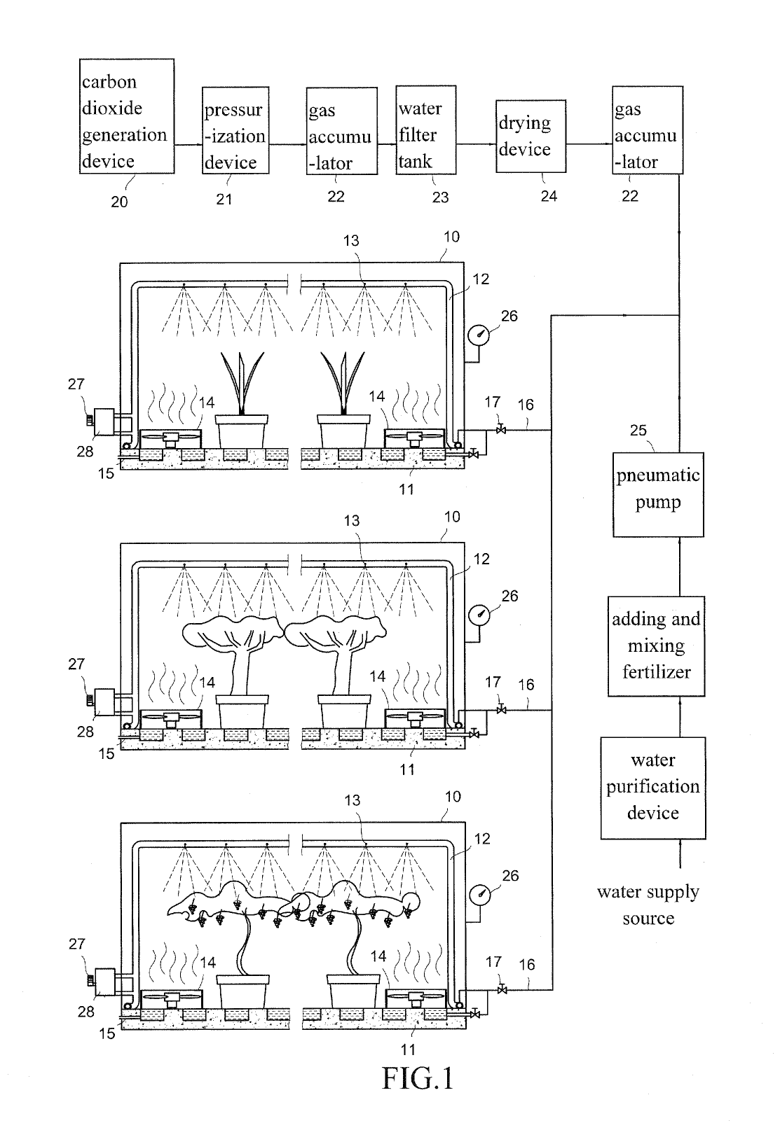

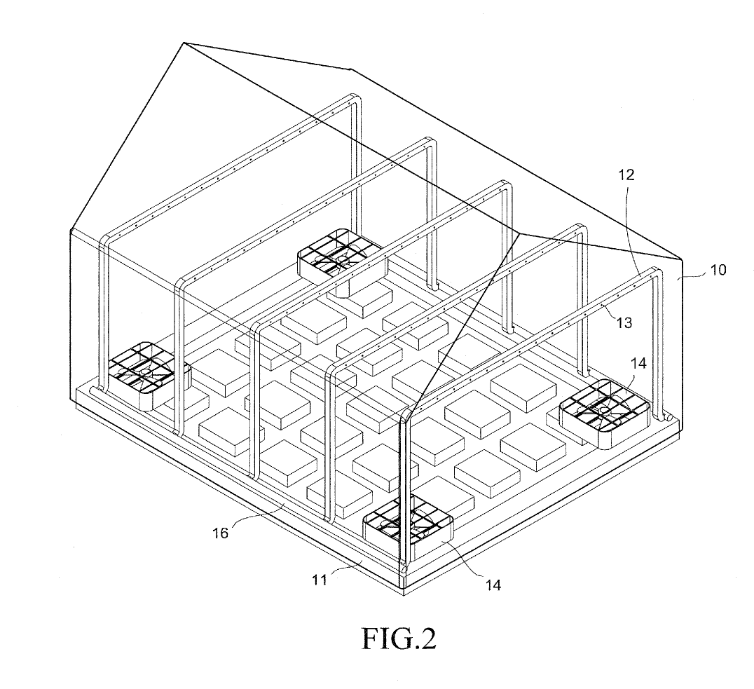

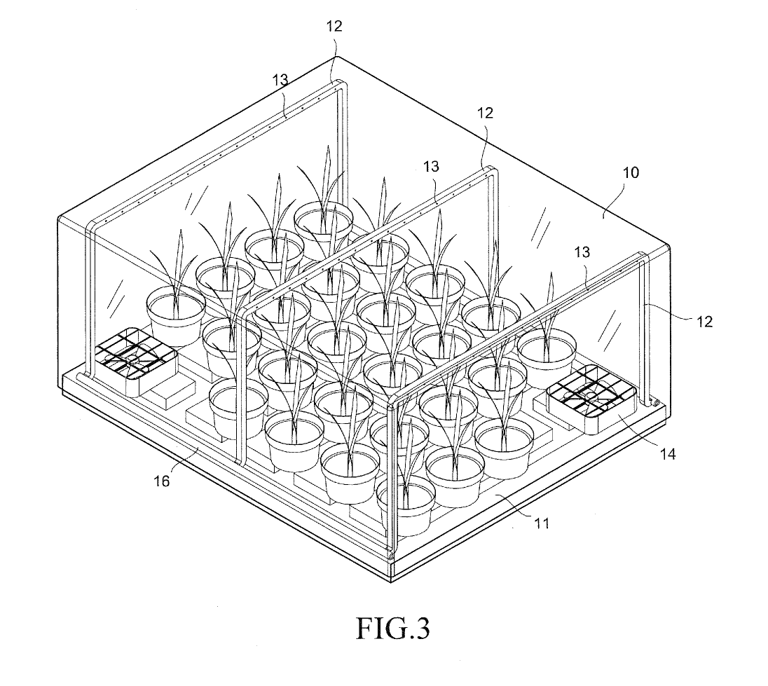

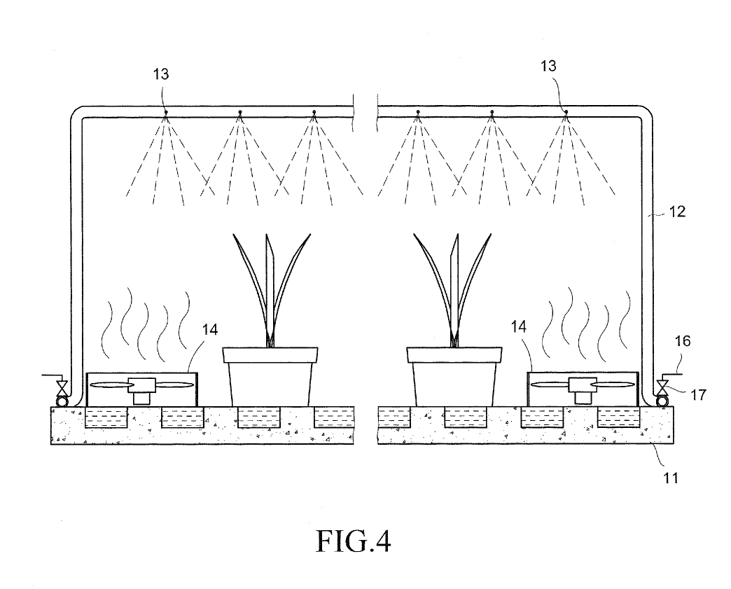

The present invention provides a novel method of plant cultivation, which is a novel cultivation method that allows for classification cultivation of plants according to different categories of plants. The overall arrangement of plant cultivation according to the present invention is illustratively shown in FIGS. 1-4 of the attached drawings, in which a pre-manufactured assembled box-like container is used as a cultivation container 10. Preferably, the container is constructed as an openable assembled structure of halves of box. The opening rim of the assembled container is provided with an appropriate sealing structure for isolation and separation of the inside of the container from the outside atmosphere. The container 10 has a bottom that forms a water reservoir area comprising a water storage tank 11. The top of the water reservoir forms a board on which plants that are planted in receptacles and appropriately watered are arranged. A proper amount of water is stored in the water reservoir area and the cultivation container is closed by a cover. The container 10 is made of a suitable light-transmitting material. Simple connection water pipes 12 are arranged inside the container and extend to the outside, with valves for control of opening/closing mounted thereto, and the water pipes 12 are mounted with nozzles 13, which are arranged in an equally spaced manner, to realize proper supplement of gas, water, and nutrients that are needed for plant cultivation from the outside to realize cultivation in a manner similar to greenhouse cultivation and thus constitutes a complete arrangement for plant cultivation according to the present invention.

In respect of the cultivation container 10 used in the present invention, the size and volume is selected depending on the practical needs and the species of plants to be cultivated, and thus, the container can be installed in the form of a box-like container or is alternatively directly enclosed and shielded to form a greenhouse-like structure. A container 10 that has a small volume can be used in general small-scale cultivation or household cultivation, such as growing vegetables, wherein the interior structure can be made simple but with only the bottom thereof forming a recessed water storage tank 11 for water recovery and a top having a surface to which connection pipes 12 for supplement of water and gas from the outside, which through arrangement of nozzle 13 can be dispersed in a misty form. The enclosed container 10, after exposure to the sunlight, causes natural temperature rise, inducing a mist-full atmosphere therein to provide an environment suitable for plant growth. When the temperature is raised too high by long time exposure to sunlight, a sunshade screen may be provided to cover outside the container, or alternatively, pressurized air is employed to perform direct water spraying for the control of internal temperature, so as to achieve the best environment for the growth. When the temperature drops after sunset, the internal moisture in the form of mist will be condensed into water droplets, which naturally fall into and are collected in the water storage tank 11 set in the bottom to be available for subsequent circulation caused by exposure to sunlight again. On the support board that is set up in the lower portion of the container 10, small air blowers 14, such as ordinary fans, are provided to generate upward moving airflows, whereby the water stored in the water storage tank 11 can be caused, in the form of water vapor, to flow upward to form misty flows of fixed flowing direction and maintain proper humidity inside the container. Additionally through the supplement of carbon dioxide gas, the air inside the container can perform photosynthesis to achieve automatic control of natural growth of plants. The entire growth of plants features enclosed circulation and can almost be a self-sustaining operation, ensuring proper operation of plant cultivation and providing the efficacy of simplified management and practical economic effect.

For large plants, such as commonly seen tall plants of grapes or papaya, the entire cultivation box 10 can be set up in a large form similar to a house-like design, comprising erection of support frame or a frame formed of the water pipes 12 for water spraying that is covered, in a hermetically enclosed manner, with a light-transmitting sheet or bag like plastic material. Again, the bottom is recessed to form a water storage tank 11. The bottom of the tank is provided with drains 15 for the convenience of discharge after clean-up. At each corner of a top board or at suitable locations, hollow portions are formed for the dispersion of water vapor and with further addition of air blowers 14, the circulation enclosed inside water vapor or humidity is made better, not only effectively reducing the temperature, but also realizing necessary water supplement for the cultivated plants. The large area inside space allows for proper division for planting, facilitating management and programming of systematic cultivation, especially for cultivation of plants of which the flowers and fruits require special treatment of fertilization, for which, in the flowering period, animals, such as bees and butterflies, are allowed to carry out natural pollen mating, reaching entirely natural style of planting cultivation and ensuring the final product of flowers and fruits, whereby there is no pesticide residue and the planting technique and pest problem can be reduced to a minimum so as to achieve high quality and low skill flower and fruit cultivation management.

The plant cultivation method according to the present invention is particularly suitable for the management of large-scale cultivation. With externally arranged carbon dioxide generation device 20, carbon dioxide gas of high concentration is generated. Through a set of connected pressurization device 21, including a pressurization air compressor that is provided for pressurization, carbon dioxide can be stored in a gas accumulator 22, and after being subjected to water removal by passing through a water filter tank 23 and subsequently processed by a drying device 24 to effectively remove water and oil, the so processed carbon dioxide gas is purified to a desired extent and can be supplied through a T-shaped fitting connected to a water (gas) supply pipe 16 that extends outside the container 10 and mounted with a control valve 17 for control of opening/closing for the supply. The water supply pipe 16 is connected to a pneumatic pump 25 for pressurization and supplement of water inside the container. Supplement of nutrients for the plants is carried out by mixing proper fertilizer in water mixed and then pressurization for supplying to the water pipes arranged inside the container 10 so that the supplement of proper amount of water and nutrients can be done through the nozzles 13 mounted on the water pipes.

To ensure the safety of the entire cultivation, at one side of the container 10, a temperature detector 26 is provided for controlling the temperature rise inside the cultivation space so as to ensure the optimal temperature for cultivation and growth of plants. Particularly, especially when the temperature rise is excessively high, through the supply of pressurized air, a temperature lowering effect can be done. If water flowing is additionally provided, then the optimal condition of the internal growth environment can be properly maintained. A pressure relief valve 27 is further provided at one side of the container, whereby when excessive amount of air is contained in the container and thus induces an over-pressure condition, to ensure that the enclosure safety and hermetic effect of the container 10, the excessive pressure can be properly released. However, it is preferable that a water filter 28 is provided upstream of the pressure relief valve 27 in order to keep water inside the enclosed container 10 for the circulation and use of water. By additionally supplying carbon dioxide into the container, the need for plant photosynthesis and growth can be satisfied and also realize an appropriate sterilization effect. The overall plant cultivation system shows an additional practical efficacy of control and adjustment of the growth period of the plants.

Further, according to the plant cultivation method of the present invention, the cultivation chamber formed by the cultivation container can be of different size depending upon the difference of plants cultivated, as shown in FIG. 1, wherein multiple sets of cultivation containers 10 for different cultivations are arranged and are provided with connected air and water supply pipelines for linked control, so that the size of the entire plantation can achieve a scale of economic mass production and relatively, the overall cost of planting cultivation can be reduced with diversified cultivation. Further, successive cultivation of the same plants in different time periods can be performed so that the supply of agricultural product can be made stable without being affected by weather conditions. Further, through temperature control for plant growth inside the container 10, the harvesting period is no longer subjected to any constrain. Particularly, the cultivation method provided by the present invention is not limited to hydroponics, and is also applicable to the general soil cultivation so that the production of agriculture is not constrained by harvesting and change of weather and seasons and programmed production and cultivation can be actually realized. Thus, the present invention is a great innovation of the plant cultivation techniques and the whole installation can handle diversified and changeable cultivation of various plants and can be considered a breakthrough of the traditional plant cultivation, completely meeting the needs of planned economy and practical applications. Thus, the present invention is a great innovation of plant cultivation.

In summary, the present invention provides a novel plant cultivation method, which adopts an enclosed cultivation space for separation from the outside atmosphere and thus isolation from pests and diseases, so as to eliminate the concerns of application of pesticides and also achieve spatial arrangement for planned and secured cultivation through control of air, water, and nutrients that are necessary for plant growing in a manner of regulated supplement of external pressurized air, whereby success rate of plant cultivation is raised and undesired working hours spent in cultivation can be saved to realize simplification of plant cultivation and meet the needs of simple operation and practice of individual cultivation of various plants. Particularly, an enclosed space of cultivation is used, so that water and air contained therein can be cyclically used in a circulatory manner and the costs for supplement management can be minimized. In view of the cultivation management of plants, the present invention is a novel idea and is a brand new way of cultivation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A plant cultivation method comprising a cultivation container and pipes and spraying devices arranged inside the cultivation container and devices for pressurization, drying, and water filtering used to generate pressurized air, characterized in that the cultivation container comprises an enclosed configuration having an inner bottom forming a water reservoir device and a top to which a piping arrangement for uniform water spraying is mounted, a water supply pipe having an end extending outside the container and coupled with a control valve for control of opening/closing for supply of water and/or air, the container being provided with a temperature detector, which works with timely supply of pressurized air generated by a pressurization device and water flow externally connected to the container to achieve temperature regulation of the cultivation space, the container being provided with a pressure relief device for automatic pressure relief when internal pressure of the container get excessive, with a water filter device being properly set up, water entraining the released air being returned to the water reservoir device, whereby water, air, and nutrients inside the cultivation space are cyclically used in a circulatory manner so as to achieve plant cultivation in a simple, safe, and practical manner.

2. The plant cultivation method according to claim 1, wherein a top side the water reservoir is provided with air blowing means at a suitable location to timely cause flowing of water vapor.

3. The plant cultivation method according to claim 1, wherein an external end of the water supply pipe is coupled to a pneumatic pump for assisting supplementing of air, water, and nutrients for plant cultivation.

4. The plant cultivation method according to claim 1, wherein the cultivation container has a size that is varied according to the plants cultivated therein.

5. The plant cultivation method according to claim 1, wherein the pressurization device comprises an air compressor.

6. The plant cultivation method according to claim 1, wherein the air compressor is connected to a carbon dioxide generation device for pressurization of carbon dioxide.

7. The plant cultivation method according to claim 5, wherein the air compressor is connected to a carbon dioxide generation device for pressurization of carbon dioxide.

8. The plant cultivation method according to claim 1, wherein the piping arranged inside the container serves as a frame for erection of the container.

9. The plant cultivation method according to claim 2, wherein the air blowing means comprises one or more air blowers.
